(19) United States
(12) Patent Application Publication
(10) Pub. No.: US 2009/0102594 A1
(43) Pub. Date: Apr. 23, 2009

(54) FUSE

(76) Inventor: William Ogilvie, Herts (GB)

Correspondence Address: SUGHRUE MION, PLLC, 2100 PENNSYLVANIA AVENUE, N.W., SUITE 800, WASHINGTON, DC, 20037, US

(21) Appl. No.: 12/066,987

(22) PCT Filed: Jun. 12, 2006
(86) PCT No.: PCT/GB2006/002141

§ 371 Date: Jul. 22, 2008

(30) Foreign Application Priority Data
Sep. 23, 2005 (GB) 0519489.9

(51) Int. Cl. B05D 5/12; H01H 85/04

(52) U.S. Cl. 337/296; 427/123

(57) ABSTRACT

A method of creating a fuse. The method comprises the steps of creating a fusible link electrically connecting a first terminal portion to a second terminal portion, the fusible link, the first terminal portion and the second terminal portion being made of a first electrically conductive material; and spraying a coating of a second electrically conductive material onto the fusible link. The second electrically conductive material has a lower melting point than the first electrically conductive material and is absorbable in the first electrically conductive material.

The present invention is directed to a fuse which can withstand required current durability cycles while at the same time conforming to required blow curves.

Various prior art designs exist for both individual fuses and fuse arrays. The required fuse performance (current rating, etc), materials used, size of fuse, and number of assembled parts, all vary to a degree.

The automotive industry requires compact fuse solutions for vehicles. Fuses can be connected to, for example, batteries, for supplying electric power to electric wires through a plurality of fuse-links.

Fuse array units can also be connected to the battery of a vehicle and typically comprise a plurality of fuse-links connecting a central terminal to a plurality of secondary terminals, each of which is connected to the central terminal by way of an electrically conductive fuse-link.

The automotive industry requires high current value fuse array units. Typically, these high current fuse array units comprise a plurality of fuse elements arranged in a parallel array and stamped out of a single piece of copper alloy or other electrically conductive material.

Every application requires a fuse with a specific blow curve. In order to achieve certain blow curves, it has previously been necessary to fabricate fuse-links out of zinc sheets. Zinc fuses provide different blow curves to copper in that zinc has a lower melting point. This solution provides a disadvantage in that zinc has lower ductility than copper and therefore provides less design scope when fabricating a fuse array, as the lack of ductility limits the shapes that the zinc sheet can be formed or bent into. Furthermore, zinc's lower ductility will make it prone to breaking while a particular piece is either being stamped out or cut out of a sheet.

In order to remedy this shortcoming, prior art fuses have been created by using copper/copper alloy plates which are put into contact with tin. Because of the fact that tin has a lower melting point than the copper/copper alloy, it will, once sufficient current is passed through it, dissolve into the copper/copper alloy, thereby lowering the melting point of the copper/copper alloy plate and accelerating the process of liquefaction. Thus, by putting a fusible portion of copper in contact with tin, prior art methods have provided fusible links which are closer to required blow curves.

However, during current cycling tests, the copper/copper alloy plate rises in temperature. If the copper/copper alloy plate and tin combination is used, the higher temperature involved, causes the tin to prematurely dissolve into the tin. Thus, the fuse rating of the fusible link is effectively reduced. However, as mentioned above, if the copper/copper alloy is used without the tin, certain required blow curves can simply not be achieved.

To remedy this problem, prior art devices have used copper/copper alloy plates with zinc instead of copper. Because zinc has a higher melting point than tin, the fuses made using this method are less sensitive to cycling tests.

Unfortunately, because of the fact that these fuses use a material which will dissolve into copper at a higher temperature, it is very difficult to get the blow curves which one can get with the tin/copper device.

The problem with this method is that when copper comes into contact with oxygen, a thin layer of copper oxide is formed on it's surface. This layer of copper oxide will have different thermal and reactive properties than the copper itself. More specifically, copper oxide will have a higher melting point and will be less reactive than copper. Thus, because of the fact that the zinc sheet is in contact with the copper oxide and not the copper itself, the process of dissolution of the zinc into the copper will take more time and energy to transpire.

Also, in order to fix the zinc to the copper, one must either machine the copper in order for it to physically contain a piece of zinc, or, more typically, designs have been made up of assembled parts, including nuts, bolts and washers. These added individual parts lead to extra size, weight, complexity and cost of the fuse arrays.

To remedy this, prior art fuses have melted zinc onto copper fusible links. This has provided the advantage of attaching the zinc to the copper fusible link without the use of mechanical attaching means such as nuts, bolts, etc.

The disadvantage of this solution is that by pouring molten zinc onto the surface of the copper fusible link, areas of copper which are exposed to air are heated and the depth of the layer of copper oxide on the surface of those areas is increased. This, as mentioned above, has disadvantages in regard to creating a thermal and reactive insulating barrier of copper oxide between the metals, thereby prohibiting the attainment of specific blow curves.

Consequently, another solution must be sought for providing a high current fuse-link which can withstand required current durability cycles while at the same time conforming to required blow curves

The present invention provides a method of creating a fuse, the method comprising the steps of:

creating a fusible link electrically connecting a first terminal portion to a second terminal portion, the fusible link, the first terminal portion and the second terminal portion being made of a first electrically conductive material; and

spraying a coating of a second electrically conductive material onto the fusible link, the second electrically conductive material having a lower melting point than the first electrically conductive material and being absorbable in the first electrically conductive material.

In the Drawings:

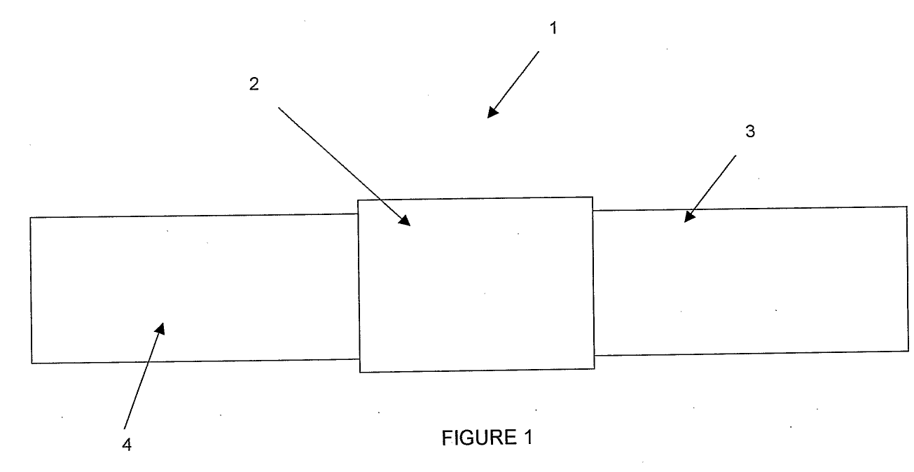

FIG. 1 is a representation of a single fuse according to the present invention, and

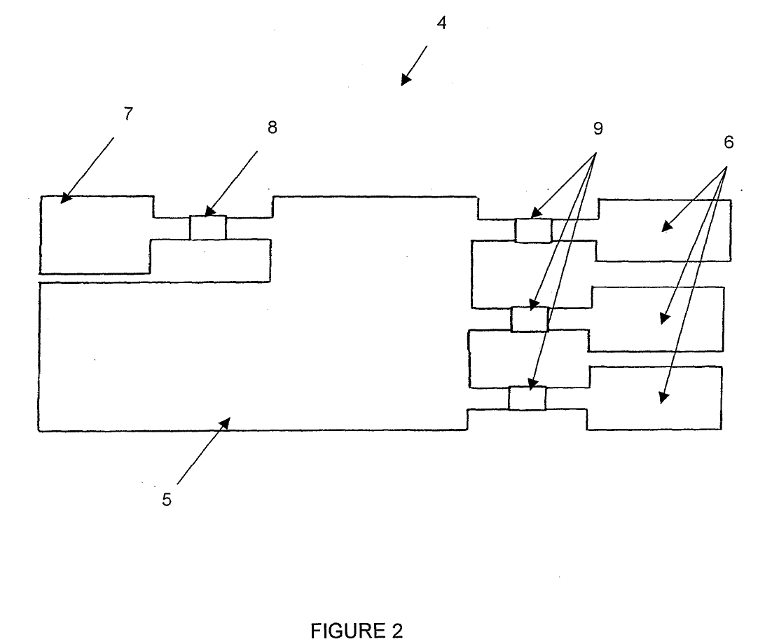

FIG. 2 is a representation of a fuse array unit according to the present invention.

With reference to FIG. 1, the present invention provides a fuse element 1 comprising a first terminal 4 and a second terminal 3. The first terminal 4 and the second terminal 3 are connected together via a fuse-link (not shown). The first terminal 4, the second terminal 3 and the fuse-link may be formed of a single piece of conductive material. The piece of conductive material can be stamped out or cut out of a larger sheet. Alternatively, the single piece of conductive material may be sprayed on to a dielectric using cold gas-dynamic spraying. The conductive material can be any suitable conductive material such as copper or copper alloy.

The fuse-link further comprises a coating 2 of a conductive material having a lower melting point than that of the fuse-link and being able to be reactively absorbed by the material of the fuse-link. The coating 2 can be made of any suitable conductive material such as zinc or tin.

The coating 2 material is attached to the fuse-link by cold gas dynamic spraying. When the coating 2 is applied to the fuse-link, the copper oxide surface is partially torn from the copper core and replaced by a layer of the coating material. The kinetic energy of the zinc particles is sufficient to penetrate any remaining layer of copper oxide. This provides an air tight bond between the two and second materials, thereby eliminating the unwanted barrier of oxidated material which would hinder the transfer of heat as well as the chemical reactivity between the two materials.

Another advantages of using cold gas dynamic spraying is the fact that the entire process can be conducted at low temperature, thereby reducing the risk of increasing the thickness of the copper oxide layer on the fuse-link. Finally, there are multiple manufacturing advantages to using cold gas dynamic spraying. The manufacturing flexibility, particularly when both the copper fuse-link and the zinc coating 2 can be cold gas dynamic sprayed onto a substrate, clearly provides advantages over known methods of making fuses. For example, these advantages provide for the possibility of permitting the “in situ” manufacture of fuses on various substrates, including Printed Circuit Boards (PCBs).

Now, with reference to FIG. 2, the present invention also provides a fuse array unit 4 which comprises a main terminal 5 and a plurality of secondary terminals 6, 7. The size and shape of the terminals will effect their current load rating. Between each secondary terminal and the main terminal is a fuse-link. As in the first embodiment, the main terminal 5, the secondary terminals 6, 7 and the fuse-links are formed of a single piece of conductive material. The piece of conductive material can be stamped out or cut out of a larger sheet. Alternatively, the single piece of conductive material may be sprayed on to a dielectric using cold gas-dynamic spraying. The conductive material can be any suitable conductive material such as copper or copper alloy.

Each fuse-link further comprises a coating, 8, 9 of a conductive material having a lower melting point than that of the fuse-link material. The coatings 8, 9 can be made of any suitable conductive material such as zinc or tin.

The coating can be applied by way of cold gas-dynamic spraying.

1. A method of creating a fuse, the method comprising the steps of:
creating a fusible link electrically connecting a first terminal portion to a second terminal portion, the fusible link, the first terminal portion and the second terminal portion being made of a first electrically conductive material; and
spraying a coating of a second electrically conductive material onto the fusible link, the second electrically conductive material having a lower melting point than the first electrically conductive material and being absorbable in the first electrically conductive material.

2. The method according to claim 1, wherein the coating is applied to the fusible link using cold gas dynamic spraying.

3. The method according to claim 1, wherein the first terminal portion, the second terminal portion and the fusible link are formed of a single piece of material.

4. The method according to claim 3, wherein the single piece of material is formed by punching or cutting it out of a sheet of that material.

5. The method according to claim 3, wherein the single piece of material is formed by spraying that material onto another surface.

6. The method according to claim 1, wherein the first terminal portion, the second terminal portion and the fusible link are formed of a single piece of copper.

7. The method according to claim 1, wherein the coating is formed of tin.

8. The method according to claim 1, wherein the coating is formed of zinc.

9. A fuse made according to the method of claim 1.

10. A fuse array comprising a plurality of fuses made according to the method of claim 1.
